(19) United States
(12) Patent Application Publication
(10) Pub. No.: US 2019/0327143 A1
(43) Pub. Date: Oct. 24, 2019

(54) WIRELESS COMMUNICATION EQUIPMENT AND METHOD FOR SETTING OPERATION MODE THEREOF

(71) Applicant: HUMAX CO., LTD., Yongin (KR)

(72) Inventors: Hee Jung KIM, Seoul (KR); Nam Kyu CHO, Yongin-si (KR)

(21) Appl. No.: 16/279,128

(22) Filed: Feb. 19, 2019

(30) Foreign Application Priority Data
Apr. 24, 2018 (KR) 10-2018-0047487

(51) Int. Cl. H04L 12/24; H04W 88/10; H04L 29/12

(52) U.S. Cl. CPC H04L 41/0816; H04L 61/256; H04L 61/2015; H04W 88/10

(57) ABSTRACT

Wireless communication equipment includes a communication interface and a processor electrically connected to the communication interface. The processor is configured to set an operation mode of the wireless communication equipment to a router mode or an extender mode, based on a selection of a user of the wireless communication equipment, to configure a network connection such that the wireless communication equipment operates in the router mode, when the operation mode is set to the router mode, and to configure the network connection such that the wireless communication equipment operates in one of a plurality of sub modes included in the extender mode based at least partly on a first connection state between the wireless communication equipment and an external device or a second connection state between the wireless communication equipment and user equipment, when the operation mode is set to the extender mode.

### CROSS-REFERENCE TO RELATED APPLICATION

This application claims the benefit of priority under 35 U.S.C 119(a) to Korean Patent Application No. 10-2018-0047487, filed in the Korean Intellectual Property Office on Apr. 24, 2018, the entire contents of which are incorporated herein by reference.

### TECHNICAL FIELD

Embodiments of the present disclosure relate to a technology for setting an operation mode of wireless communication equipment.

### BACKGROUND

A wireless network allows a user to access various pieces of content conveniently through user equipment such as a personal computer (PC), a smartphone, and a tablet PC. Various pieces of wireless communication equipment such as a router, an extender (e.g., a repeater, a wireless bridge, an access point (AP), and the like), and the like may be used to establish a wireless network. In recent years, there have been an increasing number of users who utilize pieces of wireless communication equipment to utilize a wireless network without speed delay and a shadow area indoors.

Pieces of wireless communication equipment such as a separate extender, a LAN switch, and the like are also present in the market, but users may utilize a router as an extender, a LAN switch, or the like by changing the operation mode of the router to save cost. However, the conventional router needs to perform a configuration composed of a plurality of steps by using a web user interface (UI), when changing the operation mode. Even though one of the steps is set incorrectly, the change of the operation mode may fail, when changing the operation mode. Furthermore, since users do not know what the wrong configuration is, it may be difficult for users who lack knowledge of the network to change the operation mode.

### SUMMARY

The present disclosure has been made to solve the above-mentioned problems occurring in the prior art while advantages achieved by the prior art are maintained intact.

To solve the above-mentioned problems and tasks issued in the present disclosure, embodiments of the present disclosure may make it possible to use a piece of wireless communication equipment in various operation modes without complex setting process of a user, by improving a method of changing the operation mode.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, wireless communication equipment may include a communication interface and a processor electrically connected to the communication interface. The processor may be configured to set an operation mode of the wireless communication equipment to a router mode or an extender mode, based on a selection of a user of the wireless communication equipment, to configure a network connection such that the wireless communication equipment operates in the router mode, when the operation mode is set to the router mode, and to configure the network connection such that the wireless communication equipment operates in one of a plurality of sub modes included in the extender mode based at least partly on a first connection state between the wireless communication equipment and an external device or a second connection state between the wireless communication equipment and user equipment, when the operation mode is set to the extender mode.

According to an embodiment, the wireless communication equipment may further include a switch selecting the operation mode. The processor may be configured to set the operation mode to the router mode or the extender mode based on a state of the switch.

According to an embodiment, the processor may be configured to receive an input of the user for a selection of the operation mode from the user equipment through a user interface provided by the user equipment, and to set the operation mode to the router mode or the extender mode based on the input of the user.

According to an embodiment, the processor may be configured to enable network address translation (NAT) and dynamic host configuration protocol (DHCP) and to change a local domain provided to the user equipment so as to correspond to the router mode, when the operation mode is set to the router mode.

According to an embodiment, the processor may be configured to disable NAT and DHCP; and to change a local domain provided to the user equipment so as to correspond to the extender mode, when the operation mode is set to the extender mode.

According to an embodiment, the plurality of sub modes includes a repeater mode, a wireless bridge mode, and an access point (AP) mode.

According to an embodiment, the processor may be configured to configure the network connection such that the wireless communication equipment operates in the repeater mode, when the wireless communication equipment is connected to the external device and the user equipment wirelessly.

According to an embodiment, the processor may be configured to configure the network connection such that the wireless communication equipment operates in the wireless bridge mode, when the wireless communication equipment is connected to the external device wirelessly and is connected to the user equipment by wire.

According to an embodiment, the processor may be configured to configure the network connection such that the wireless communication equipment operates in the AP mode, when the wireless communication equipment is connected to the external device by wire.

According to an embodiment, the processor may be configured to transmit a selection result for at least part of the repeater mode, the wireless bridge mode or the AP mode to the user equipment and to receive a user input for verifying the selection result from the user equipment, when the operation mode is set to the extender mode.

According to an embodiment, the processor may be configured to configure the network connection to an external device, which is selected by the user, from among a plurality of external devices, when the operation mode is set to the extender mode.

According to another aspect of the present disclosure, an operation mode setting method of wireless communication equipment includes setting an operation mode of the wireless communication equipment to a router mode or an extender mode, based on a selection of a user of the wireless communication equipment, configuring a network connection such that the wireless communication equipment operates in the router mode, when the operation mode is set to the router mode, and configuring the network connection such that the wireless communication equipment operates in one of a plurality of sub modes included in the extender mode based at least partly on a first connection state between the wireless communication equipment and an external device or a second connection state between the wireless communication equipment and user equipment, when the operation mode is set to the extender mode.

### BRIEF DESCRIPTION OF THE DRAWINGS

The above and other objects, features and advantages of the present disclosure will be more apparent from the following detailed description taken in conjunction with the accompanying drawings:

FIG. 1 illustrates an operation mode of wireless communication equipment, according to an embodiment;

FIG. 2 illustrates an exemplary operation environment of wireless communication equipment, according to an embodiment;

FIG. 3 is a block diagram illustrating a configuration of wireless communication equipment, according to an embodiment;

FIG. 4 is a flowchart for describing an operation mode setting method of wireless communication equipment, according to an embodiment;

FIG. 5 illustrates an operation of a switch included in wireless communication equipment, according to an embodiment;

FIG. 6 illustrates an exemplary user interface provided to set an operation mode of wireless communication equipment, according to an embodiment;

FIG. 7 illustrates an exemplary user interface provided to set an operation mode of wireless communication equipment, according to an embodiment;

FIG. 8 illustrates an exemplary user interface provided to set an operation mode of wireless communication equipment, according to an embodiment;

FIG. 9 illustrates an exemplary user interface provided to set an operation mode of wireless communication equipment, according to an embodiment; and

FIG. 10 is a flowchart for describing a web UI providing method for setting an operation mode of wireless communication equipment, according to an embodiment.

### DETAILED DESCRIPTION

Hereinafter, various embodiments of the present disclosure will be described with reference to accompanying drawings. However, it should be understood that the present disclosure is not intended to be limited to a specific embodiment, but intended to include various modifications, equivalents, and/or alternatives of the corresponding embodiment.

Various embodiments of the present disclosure and terms used herein are not intended to limit the technologies described in the present disclosure to specific embodiments, and it should be understood that the embodiments and the terms include modification, equivalent, and/or alternative on the corresponding embodiments described herein. The terms of a singular foam may include plural forms unless otherwise specified. In the disclosure disclosed herein, the expressions “A or B”, “at least one of A and/or B”, “A, B, or C”, or “at least one of A, B, and/or C”, and the like used herein may include any and all combinations of one or more of the associated listed items. Expressions such as “first,” or “second,” and the like, may express their components regardless of their priority or importance and may be used to distinguish one component from another component but is not limited to these components. When a (e.g., first) component is referred to as being “(operatively or communicatively) coupled with/to” or “connected to” another (e.g., second) component, it may be directly coupled with/to or connected to the other component or an intervening component (e.g., a third component) may be present. The size and thickness of each of the components illustrated in the drawings are shown for convenience of explanation and the present disclosure is not necessarily limited to the size and thickness of the configuration in which the present disclosure is illustrated.

Hereinafter, wireless communication equipment according to various embodiments will be described with reference to the accompanying drawings.

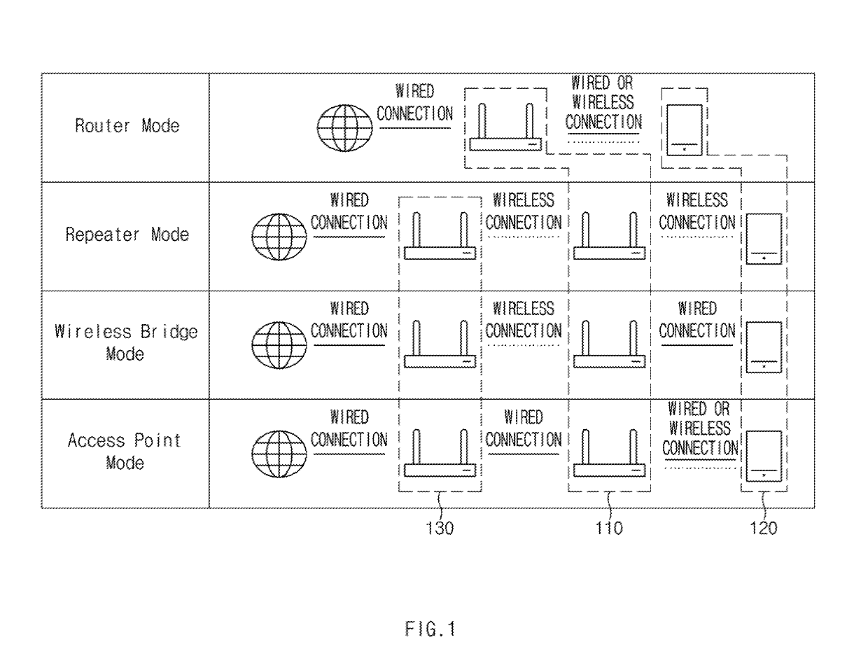

FIG. 1 illustrates an operation mode of wireless communication equipment, according to an embodiment.

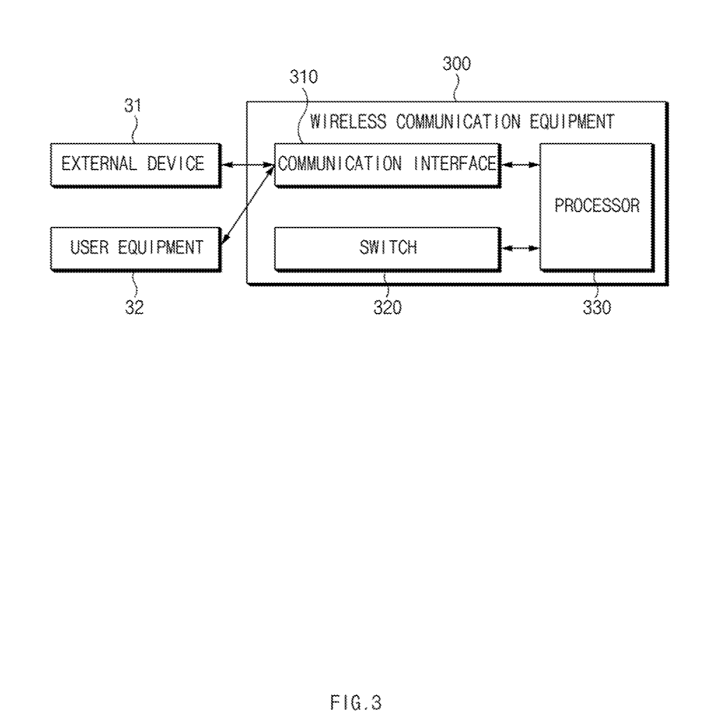

Referring to FIG. 1, wireless communication equipment 110 according to an embodiment may operate in various operation modes. For example, the wireless communication equipment 110 may operate in a router mode, a repeater mode, a wireless bridge mode (or a Wi-Fi bridge mode), or an AP mode. The wireless communication equipment 110 may automatically optimize the operation mode based on the user's selection, the connection state with an upper network 130 (e.g., an external device 31 in FIG. 3), and the connection state with a client 120 (e.g., user equipment 32 in FIG. 3). In the present disclosure, the connection state may mean a wireless connection or a wired connection.

The wireless communication equipment 110 may operate as a router, when the user selects a router mode. The wireless communication equipment 110 may be connected to Internet by wire, and may be connected to the client 120 by wire or wirelessly.

The wireless communication equipment 110 may operate as a repeater, a wireless bridge, or an AP, when the user selects an extender mode. The mode of the wireless communication equipment 110 may be converted to an appropriate mode, based on a first connection state between the upper network 130 and the wireless communication equipment 110 and a second connection state between the client 120 and the wireless communication equipment 110. For example, the wireless communication equipment 110 may operate as the repeater, when each of the first connection state and the second connection state is a wireless connection. For another example, the wireless communication equipment 110 may operate as the wireless bridge, when the first connection state is a wireless connection and the second connection state is a wired connection. For another example, the wireless communication equipment 110 may operate as the AP, when the first connection state is a wired connection and the second connection state is a wired or wireless connection.

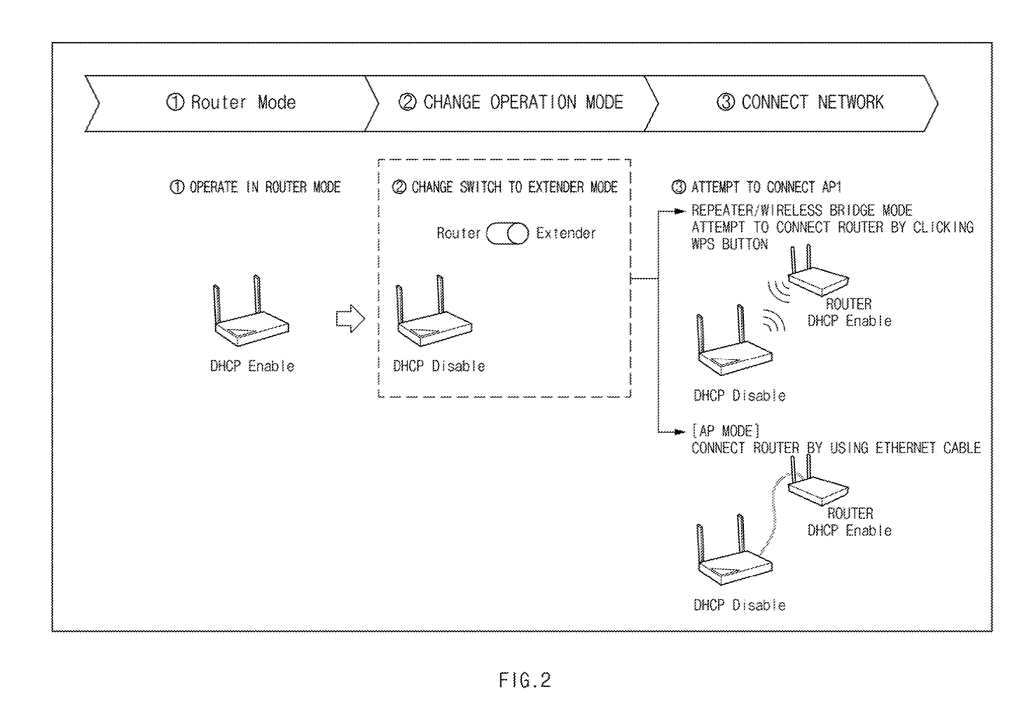

FIG. 2 illustrates an exemplary operation environment of wireless communication equipment, according to an embodiment.

Referring to FIG. 2, wireless communication equipment according to an embodiment may support various operation modes. For example, the wireless communication equipment may operate in a router mode. In the router mode, the wireless communication equipment may enable a dynamic host configuration protocol (DHCP).

A user of the wireless communication equipment may manipulate a switch included in the wireless communication equipment. The operation mode of the wireless communication equipment may be changed from the router mode to an extender mode by the manipulation of the switch. In the extender mode, the wireless communication equipment may disable the DHCP.

In the extender mode, the wireless communication equipment may operate in a repeater mode, a wireless bridge mode, or an AP mode. The wireless communication equipment may operate in the repeater mode or the wireless bridge mode, when the wireless communication equipment is wirelessly connected to an external router. The wireless communication equipment may be connected to the external router, when a Wi-Fi protected setup (WPS) button of the wireless communication equipment and a WPS button of the external router are pressed. The wireless communication equipment may operate in the AP mode, when the wireless communication equipment is connected to the external router by wire. The wireless communication equipment may be connected to the external router via an Ethernet cable.

FIG. 3 is a block diagram illustrating a configuration of wireless communication equipment, according to an embodiment.

Referring to FIG. 3, wireless communication equipment 300 according to an embodiment may include a communication interface 310, a switch 320, and a processor 330. For example, the wireless communication equipment 300 may operate as a router or an extender (e.g., a repeater, a wireless bridge, or an AP).

The communication interface 310 may include a wired/wireless interface. The communication interface 310 may be connected to the external device 31 (e.g., a router, an AP, or an external server) and the user equipment 32.

The switch 320 may be configured to select an operation mode. For example, the switch 320 may be configured such that a user selects a router mode or an extender mode. The switch 320 may be omitted depending on implementation of the present disclosure. In this case, the router mode or the extender mode may be selected through a web UI displayed in the user equipment 32.

The processor 330 may be electrically connected to the communication interface 310 and the switch 320. The processor 330 may control the components such as the communication interface 310, the switch 320, and the like and may perform various data processing and calculation.

According to an embodiment, the processor 330 may set the operation mode of the wireless communication equipment 300 to the router mode or the extender mode, based on the selection of the user of the wireless communication equipment 300. The processor 330 may set the operation mode primarily depending on the user's selection. According to an embodiment, the processor 330 may set the operation mode based on the state of the switch 320 manipulated by the user. The processor 330 may set the operation mode based on a user input to the hardware switch 320. According to an embodiment, the processor 330 may receive a user input for selecting the operation mode from the user equipment 32 through a user interface provided by the user equipment 32 and may set the operation mode based on the user input. The processor 330 may set the operation mode based on the user input to a menu in the web UI provided through the user equipment 32.

According to an embodiment, the processor 330 may configure a network connection such that the wireless communication equipment 300 operates in the router mode, when the operation mode is set to the router mode. The processor 330 may enable network address translation (NAT) and dynamic host configuration protocol (DHCP) and may change a local domain provided to the user equipment 32 so as to correspond to the router mode, when the operation mode is set to the router mode. The web page corresponding to the local domain may include the web UI for the router mode.

According to an embodiment, the processor 330 may configure a network connection such that the wireless communication equipment 300 operates in one mode of a plurality of sub modes included in the extender mode based at least partly on a first connection state between the wireless communication equipment 300 and the external router or a second connection state between the wireless communication equipment 300 and the user equipment 32, when the operation mode is set to the extender mode. The processor 330 may set the operation mode to one of the plurality of sub modes (e.g., a repeater mode, a wireless bridge mode, and an AP mode) secondarily based on the first connection state and the second connection state, when the extender mode is selected. The processor 330 may disable NAT and DHCP and may change the local domain provided to the user equipment 32 so as to correspond to the extender mode, when the operation mode is set to the extender mode. The web page corresponding to the local domain may include the web UI for the extender mode. The processor 330 may determine whether the first connection state is a wireless connection or a wired connection, by sensing the state of a port (e.g., a WAN port) connected to the external device 31. The processor 330 may determine whether the second connection state is a wireless connection or a wired connection, by sensing the connection state of a port (e.g., a LAN port) connected to the user equipment 32.

In particular, as described below, the processor 330 may configure the network connection so as to operate in a repeater mode, a wireless bridge mode, or an AP mode based on the first connection state and the second connection state. For example, the processor 330 may configure the network connection such that wireless communication equipment 300 operates in the repeater mode, when the wireless communication equipment is connected to an external router and the user equipment 32 wirelessly. For another example, the processor 330 may configure the network connection such that the wireless communication equipment 300 operates in the wireless bridge mode, when the wireless communication equipment is connected to the external router wirelessly and is connected to the user equipment 32 by wire. For still another example, the processor 330 may configure the network connection such that the wireless communication equipment 300 operates in the AP mode, when the wireless communication equipment is connected to the external router by wire. Table 1 shows a method of configuring a network connection using the switch 320.

TABLE 1

| | | | Wireless | |
|---|---|---|---|---|
| | Router mode | Repeater mode | bridge mode | AP mode |
| H/W | Being | Being located at an extender | | |
| switch | located at a | | | |
| | router | | | |
| Con- | Wire | Wireless | Wireless | Wire |
| nection | | | | |
| state | | | | |
| of WAN | | | | |
| port | | | | |
| Concept | Operating in | Upon rebooting, checking the connection | | |
| | a router | state of the WAN port, and then | | |
| | mode | automatically setting the operation mode | | |
| | | to the suitable mode. | | |
| User | Moving HW | Moving HW | Moving HW | Moving HW |
| task | switch to | switch to | switch to | switch to |
| | router mode | extender mode | extender mode | extender |
| | Connecting | Simultaneously | Simultaneously | mode |
| | the network | pressing WPS | pressing | Connecting |
| | cable | buttons of an | WPS buttons | an |
| | provided by | extender and | of an | extender |
| | ISP to the | an upper | extender and | to an |
| | WAN port | router | an upper | upper |
| | | [symbol] Settings | router | router by |
| | | using a web UI | [symbol] Settings | using an |
| | | are possible | using a web | Ethernet |
| | | | UI are | cable |
| | | | possible | |

According to an embodiment, the processor 330 may transmit the result of selecting at least part of the repeater mode, the wireless bridge mode, or the AP mode to the user equipment 32 and may receive a user input for verifying the selection result from the user equipment 32, when the operation mode is set to the extender mode. For example, after determining a sub mode based on the first connection state and the second connection state, the processor 330 may transmit the determination result of the sub mode to the user equipment 32. The user equipment 32 may output the determination result through a web UI. The user equipment 32 may receive a user input for verifying the determination result through the web UI. The processor 330 may configure the network connection in the sub mode determined in response to the user input. Table 2 shows a method of configuring a network connection using the web UI.

TABLE 2

| | | | Wireless | |
|---|---|---|---|---|
| | Router mode | Repeater mode | bridge mode | AP mode |
| Web UI | In web UI, | In web UI, selecting an extender mode | | |
| | selecting a | | | |
| | router mode | | | |
| Con- | Wire | Wireless | Wireless | Wire |
| nection | | | | |
| state | | | | |
| of WAN | | | | |
| port | | | | |
| Concept | Operating in | Upon rebooting, check the connection | | |
| | a router | state of the WAN port, and then | | |
| | mode | automatically set the operation mode to | | |
| | | the suitable mode. | | |
| User | Setting an | Setting an | Setting an | Setting an |
| Task | operation | operation mode | operation | operation |
| | mode to a | to an extender | mode to an | mode to an |
| | router mode | mode | extender mode | extender |
| | After | After | After | mode |
| | rebooting, | rebooting, | rebooting, | After |
| | connecting | simultaneously | simultaneously | rebooting, |
| | the network | pressing WPS | pressing | connecting |
| | cable | buttons of an | WPS buttons | an |
| | provided by | extender and | of an | extender |
| | ISP to the | an upper | extender and | to an |
| | WAN port | router | an upper | upper |
| | | [symbol] Settings | router | router by |
| | | through a web | [symbol] Settings | using an |
| | | UI are | through a web | Ethernet |
| | | possible | UI are | cable |
| | | | possible | |

According to an embodiment, the processor 330 may configure the network connection to an external router, which is selected by a user, from among a plurality of external routers when the operation mode is set to the extender mode. The user equipment 32 may output the list of the plurality of external routers capable of being connected to the wireless communication equipment 300. The user may select one external router from the list. The processor 330 may configure the network connection to the selected external router. The processor 330 may change the initial service set identifier (SSID) and release the security for quick recognition of the user and easy setup at the time of mode change.

As described above, a user who lacks knowledge of network equipment may easily utilize a piece of wireless communication equipment for various purposes, by automatically setting the suitable operation mode among the router mode, the repeater mode, the wireless bridge mode, and the AP mode primarily based on the user's selection or secondarily based on the connection state of the wireless communication equipment 300.

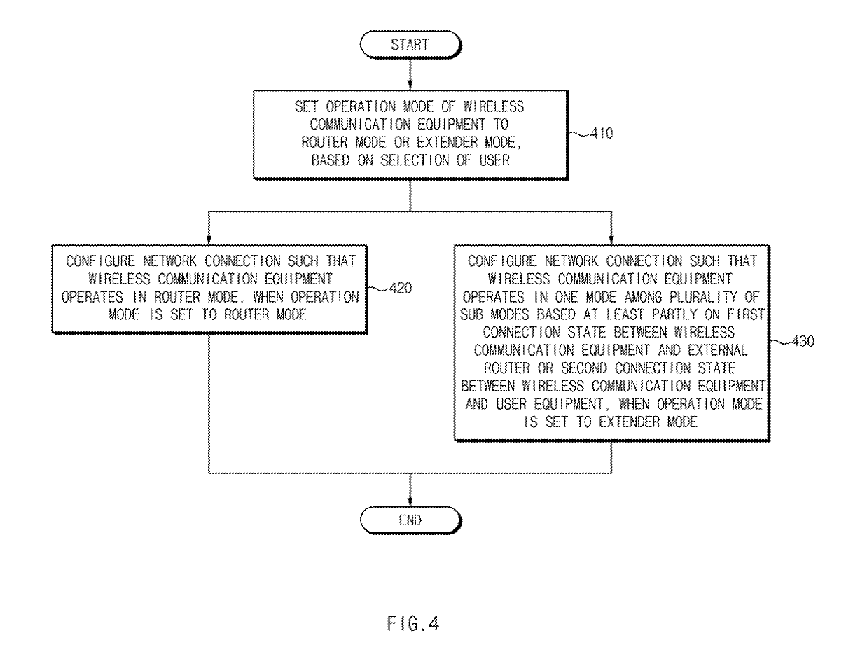

FIG. 4 is a flowchart for describing a method for setting an operation mode of wireless communication equipment, according to an embodiment.

Hereinafter, it is assumed that the wireless communication equipment 300 of FIG. 3 performs the process illustrated in FIG. 4. In addition, as described in FIG. 4, it is understood that the operation described as being executed by the wireless communication equipment 300 is controlled by the processor 330 of the wireless communication equipment 300.

Referring to FIG. 4, in operation 410, wireless communication equipment may set an operation mode of the wireless communication equipment to a router mode or an extender mode, based on the selection of a user of the wireless communication equipment. For example, the wireless communication equipment may first set the operation mode to the router mode or the extender mode, based on a user input to a switch or a web UI.

In operation 420, the wireless communication equipment may configure a network connection such that the wireless communication equipment operates in the router mode, when the operation mode is set to the router mode. For example, the wireless communication equipment may enable NAT and DHCP and may change the local domain provided to user equipment so as to correspond to the router mode, when the user selects the router mode.

In operation 430, the wireless communication equipment may configure the network connection such that the wireless communication equipment operates in one mode among a plurality of sub modes based at least partly on a first connection state between the wireless communication equipment and an external router or a second connection state between the wireless communication equipment and user equipment, when the operation mode is set to the extender mode. For example, the wireless communication equipment may secondarily determine whether each of the first connection state and the second connection state is a wireless connection or a wired connection and may configure the network connection so as to operate in a mode, which is suitable for the connection state, from among the repeater mode, the bridge mode, and the AP mode, when a user selects the extender mode.

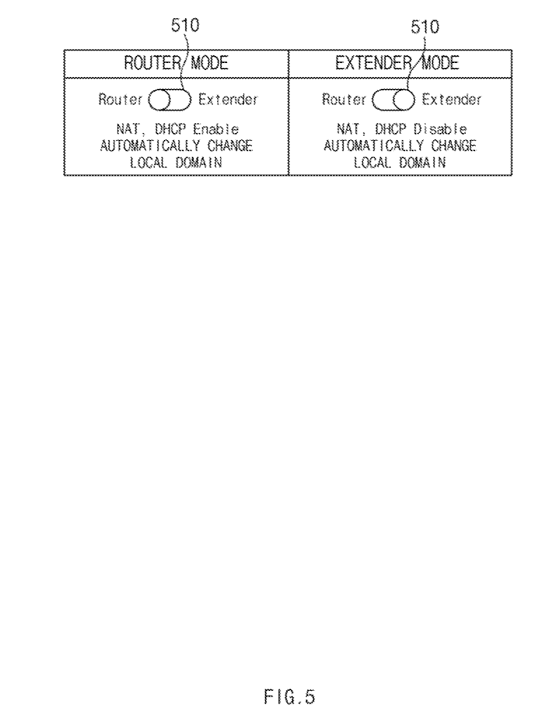

FIG. 5 illustrates an operation of a switch included in wireless communication equipment, according to an embodiment.

Referring to FIG. 5, wireless communication equipment according to an embodiment may include a switch 510 for selecting a router mode or an extender mode. The wireless communication equipment may change a default operation mode based on an input to the switch 510. The wireless communication equipment may enable NAT and DHCP and may change a local domain so as to correspond to the router mode, when the router mode is selected. The wireless communication equipment may disable NAT and DHCP and may change the local domain so as to correspond to the extender mode, when the extender mode is selected. The initial web UI may be changed automatically such that the user can easily recognizes the change of a mode after the default operation mode is changed, by changing the local domain.

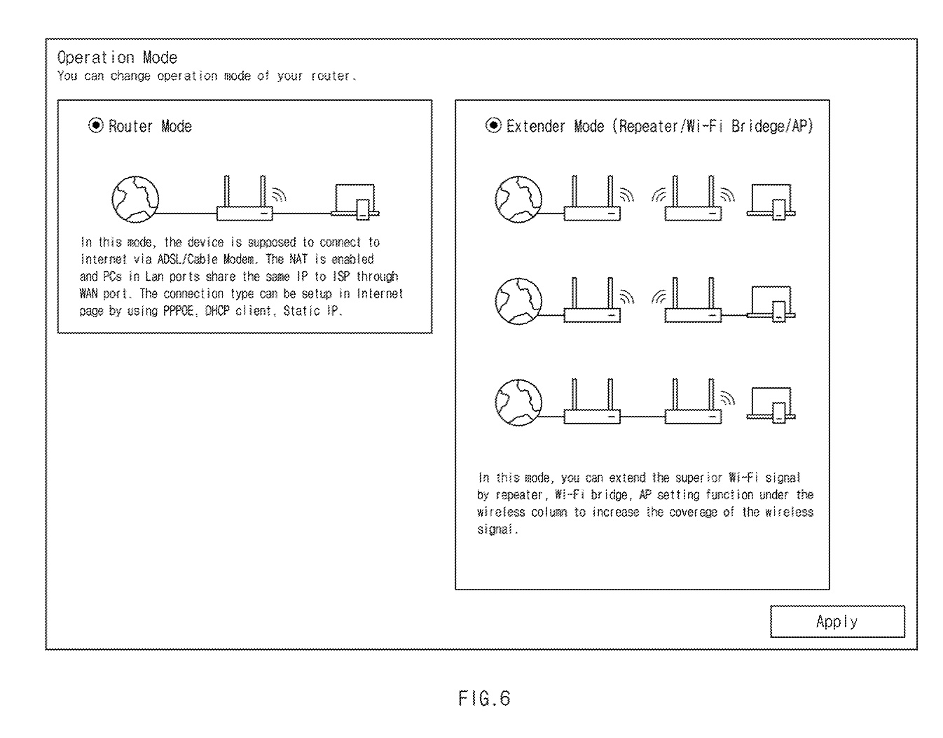

FIG. 6 illustrates an exemplary user interface provided to set an operation mode of wireless communication equipment, according to an embodiment.

Referring to FIG. 6, user equipment connected to wireless communication equipment may provide a web UI for selecting a router mode or an extender mode. The wireless communication equipment may change a default operation mode based on an input to the web UI. The wireless communication equipment may enable NAT and DHCP, when the router mode is selected on the web UI. The wireless communication equipment may disable NAT and DHCP, when the extender mode is selected.

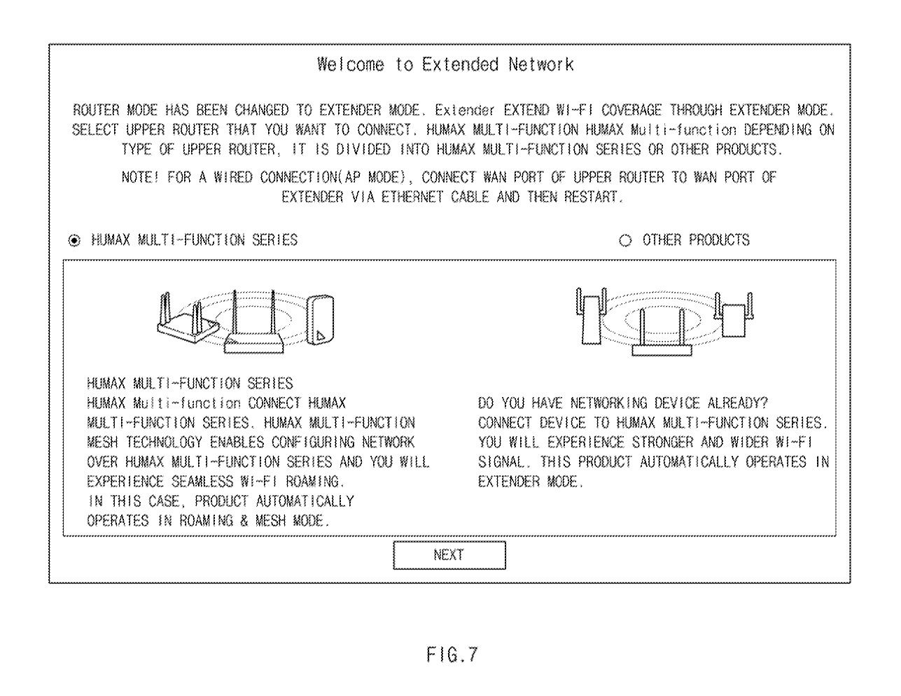

FIG. 7 illustrates an exemplary user interface provided to set an operation mode of wireless communication equipment, according to an embodiment.

Referring to FIG. 7, user equipment connected to wireless communication equipment may provide a web UI for selecting the manufacturer of the wireless communication equipment, when the operation mode of the wireless communication equipment is changed from a router mode to an extender mode. The wireless communication equipment may automatically configure a mesh network by using a mesh ID and a password and may provide a roaming service, when the manufacturer of the wireless communication equipment is the same as that of an external router. The web UI provided when the product of our own company is selected may be different from a web UI provided when the product of any other company is selected.

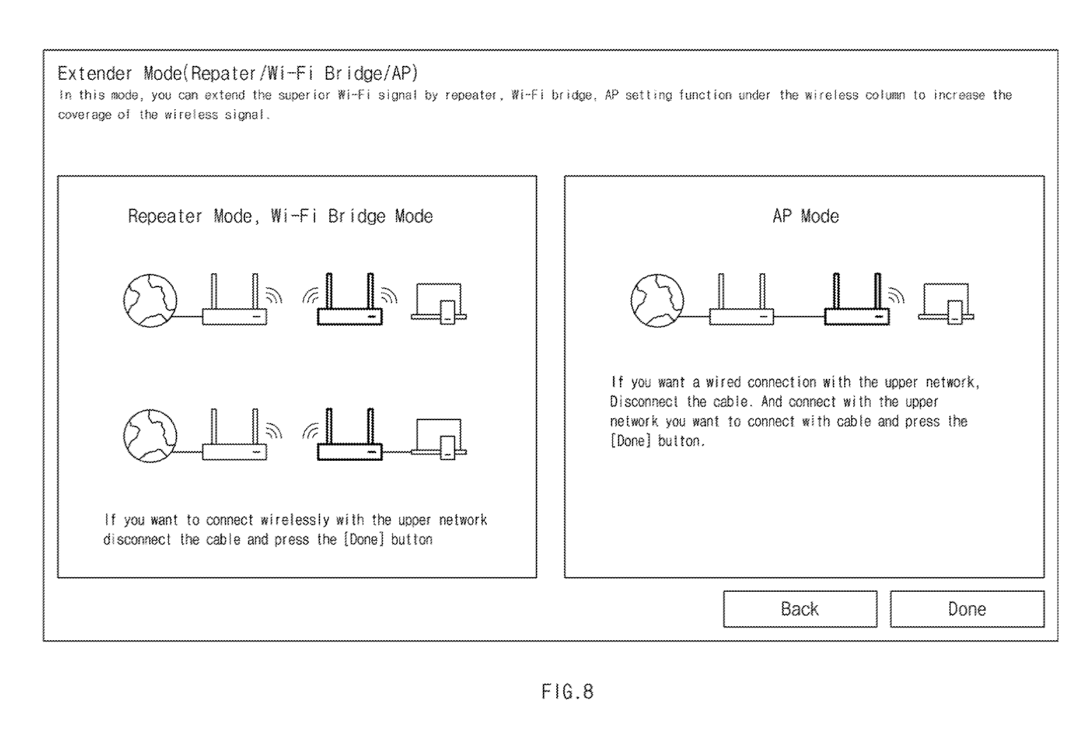

FIG. 8 illustrates an exemplary user interface provided to set an operation mode of wireless communication equipment, according to an embodiment.

Referring to FIG. 8, user equipment connected to wireless communication equipment may provide a web UI for providing a guide on a repeater and Wi-Fi bridge mode or an AP mode. The wireless communication equipment may determine a sub operation mode based at least partly on a first connection state between the wireless communication equipment and an external router or a second connection state between the wireless communication equipment and user equipment. The web UI may include a cover indicating the determined mode. For example, the web UI may change the color of the web UI area associated with the repeater and Wi-Fi mode, when it is determined that the operation mode is the repeater and Wi-Fi bridge mode; the web UI may change the color of the web UI area associated with the AP mode, when it is determined that the operation mode is the AP mode. The web UI may include a [Done] button for receiving the verification of a user. In the repeater and Wi-Fi bridge mode, the wireless communication equipment may be connected to an external router wirelessly. The wireless communication equipment may operate as a repeater, when the wireless communication equipment is connected to the user equipment wirelessly; the wireless communication equipment may operate as a Wi-Fi bridge, when the wireless communication equipment is connected to the user equipment by wire. In the AP mode, the wireless communication equipment may be connected to the external router via a cable. The wireless communication equipment may operate as an AP and may be connected to the user equipment by wire or wirelessly.

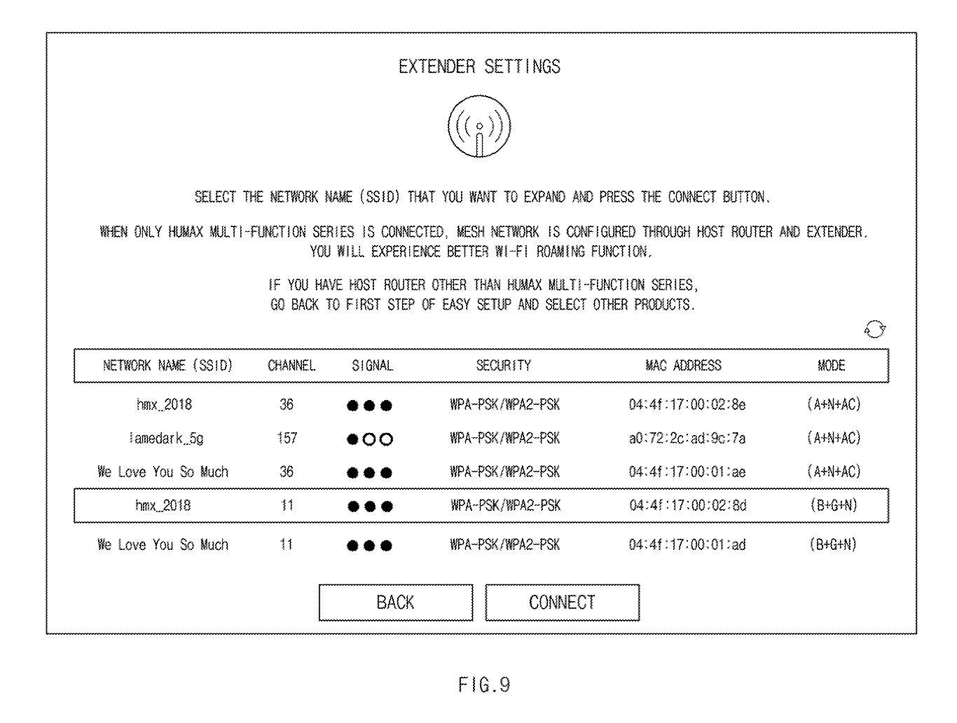

FIG. 9 illustrates an exemplary user interface provided to set an operation mode of wireless communication equipment, according to an embodiment.

Referring to FIG. 9, user equipment connected to wireless communication equipment may display a list of external routers capable of being connected to the wireless communication equipment, when the operation mode of the wireless communication equipment is set to an extender mode. The wireless communication equipment may configure a network connection, when a user selects one external router from the list. The wireless communication equipment may configure a mesh network, when the manufacturer of the wireless communication equipment is the same as the manufacturer of the selected external router. The wireless communication equipment may manually configure a network based on an input received from a user, when the manufacturer of the wireless communication equipment is different from the manufacturer of the selected external router.

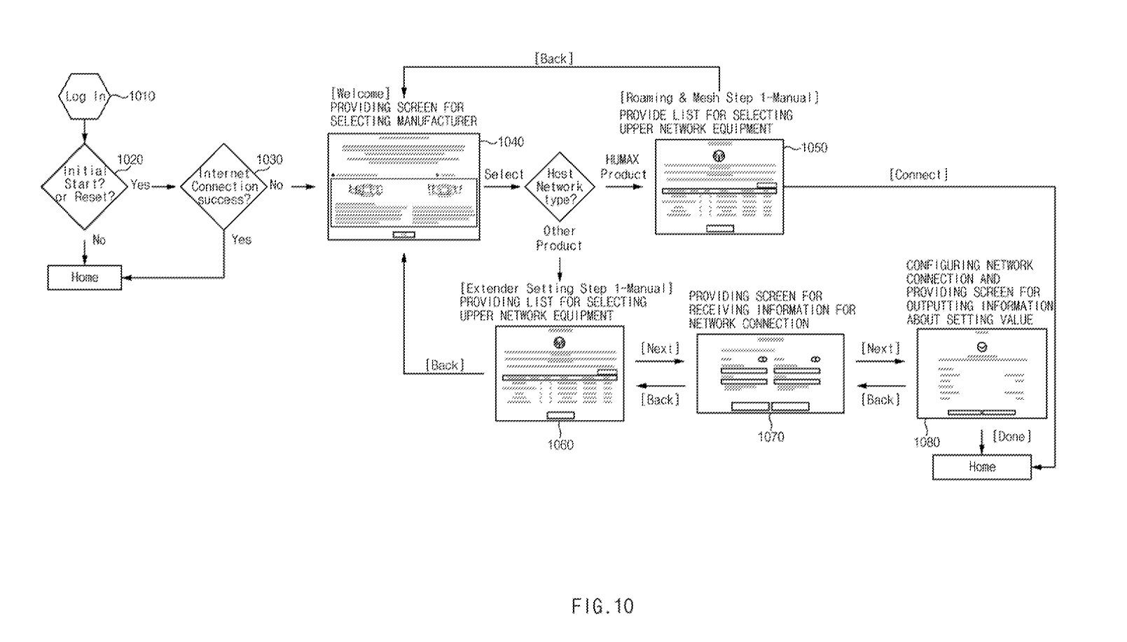

FIG. 10 is a flowchart for describing a method of providing a web UI for setting an operation mode of wireless communication equipment, according to an embodiment.

Referring to FIG. 10, in operation 1010, user equipment connected to wireless communication equipment may receive log-in information from a user and may log in. In operation 1020, the user equipment may determine whether the wireless communication equipment is started initially or is reset. In operation 1030, the user equipment may determine whether an Internet connection is successful, when the wireless communication equipment is started initially or is reset. In operation 1040, the user equipment may provide a screen for selecting the manufacturer of the wireless communication equipment.

In operation 1050, the user equipment may provide a list for selecting upper network equipment, when the wireless communication equipment and the upper network equipment are manufactured by the same manufacturer. The wireless communication equipment may automatically configure the network connection to the selected upper network equipment, when a piece of upper network equipment is selected from the list. The required user input may be minimized when the wireless communication equipment and the upper network equipment are manufactured by the same manufacturer.

In operation 1060, the user equipment may provide the list for selecting the upper network equipment, when the wireless communication equipment and the upper network equipment are manufactured by different manufacturers. In operation 1070, the user equipment may provide a screen for receiving information for the network connection, when a piece of upper network equipment is selected from the list and the password corresponding to the selected upper network equipment is entered. The user equipment may receive an SSID, a password, and the like through the provided screen. In operation 1080, the wireless communication equipment may configure the network connection and the user equipment may provide a screen for outputting information about a setting value, when the settings of wireless information are completed through the provided screen.

In the present disclosure, each block or each step may represent a part of a module, segment, or code that includes one or more executable instructions for executing a specified logical function. In addition, it should also be noted that in some alternative embodiments, the functions described in blocks or steps occur out of order. For example, two consecutive blocks or steps may, in fact, be performed substantially and concurrently, or the blocks or steps may sometimes be performed in reverse order depending on the corresponding function.

The step of the methods or algorithms described in connection with the embodiments disclosed in the specification may be directly implemented with a hardware module, a software module, or a combination of the hardware module and the software module, which is executed by a processor. The software module may reside in a random access memory (RAM), a flash memory, a read only memory (ROM), an erasable and programmable ROM (EPROM), an electrically EPROM (EEPROM), a register, a hard disk drive (HDD), a removable disc, a compact disc-ROM (CD-ROM), or any other form of storage medium known in the art. The exemplary storage medium may be coupled to the processor. The processor may read out information from the storage medium and may write information in the storage medium. Alternatively, the storage medium may be integrated with the processor. The processor and storage medium may reside in an application specific integrated circuit (ASIC). The ASIC may reside in a user terminal. Alternatively, the processor and storage medium may reside as a separate component in the user terminal.

The embodiments of the present disclosure have been described in detail with reference to the accompanying drawings. However, the present disclosure may not be necessarily limited to these embodiments and may be changed variously without departing from the technical spirit of the present disclosure. Therefore, embodiments of the present disclosure are not intended to limit the technical spirit of the present disclosure, but provided only for the illustrative purpose. Therefore, it should be understood that the above embodiments are not limiting, but illustrative. The scope of protection of the present disclosure should be construed by the attached claims, and all equivalents thereof should be construed as being included within the scope of the present disclosure.

According to various embodiments of the present disclosure, a user who lacks knowledge of network equipment may easily utilize a piece of wireless communication equipment for various purposes, by setting the operation mode of the wireless communication equipment automatically through a switch or a web UI based on a user input and the connection state of the wireless communication equipment.

Besides, a variety of effects directly or indirectly understood through this disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. Wireless communication equipment comprising:
a communication interface; and
a processor electrically connected to the communication interface,
wherein the processor is configured to:
set an operation mode of the wireless communication equipment to a router mode or an extender mode, based on a selection of a user of the wireless communication equipment;
configure a network connection such that the wireless communication equipment operates in the router mode, when the operation mode is set to the router mode; and
configure the network connection such that the wireless communication equipment operates in one of a plurality of sub modes included in the extender mode based at least partly on a first connection state between the wireless communication equipment and an external device or a second connection state between the wireless communication equipment and user equipment, when the operation mode is set to the extender mode.

2. The wireless communication equipment of claim 1, further comprising:
a switch configured to select the operation mode,
wherein the processor is configured to:
set the operation mode to the router mode or the extender mode based on a state of the switch.

3. The wireless communication equipment of claim 1, wherein the processor is configured to:
receive an input of the user for a selection of the operation mode from the user equipment through a user interface provided by the user equipment; and
set the operation mode to the router mode or the extender mode based on the input of the user.

4. The wireless communication equipment of claim 1, wherein the processor is configured to:
when the operation mode is set to the router mode,
enable network address translation (NAT) and dynamic host configuration protocol (DHCP); and
change a local domain provided to the user equipment so as to correspond to the router mode.

5. The wireless communication equipment of claim 1, wherein the processor is configured to:
when the operation mode is set to the extender mode,
disable NAT and DHCP; and
change a local domain provided to the user equipment so as to correspond to the extender mode.

6. The wireless communication equipment of claim 1, wherein the plurality of sub modes includes a repeater mode, a wireless bridge mode, and an access point (AP) mode.

7. The wireless communication equipment of claim 6, wherein the processor is configured to:
when the wireless communication equipment is connected to the external device and the user equipment wirelessly,
configure the network connection such that the wireless communication equipment operates in the repeater mode.

8. The wireless communication equipment of claim 6, wherein the processor is configured to:
when the wireless communication equipment is connected to the external device wirelessly and is connected to the user equipment by wire,
configure the network connection such that the wireless communication equipment operates in the wireless bridge mode.

9. The wireless communication equipment of claim 6, wherein the processor is configured to:
when the wireless communication equipment is connected to the external device by wire,
configure the network connection such that the wireless communication equipment operates in the AP mode.

10. The wireless communication equipment of claim 6, wherein the processor is configured to:
when the operation mode is set to the extender mode,
transmit a selection result for at least part of the repeater mode, the wireless bridge mode or the AP mode to the user equipment; and
receive a user input for verifying the selection result from the user equipment.

11. The wireless communication equipment of claim 1, wherein the processor is configured to:
when the operation mode is set to the extender mode,
configure the network connection to an external device, which is selected by the user, from among a plurality of external devices.

12. An operation mode setting method of wireless communication equipment comprising:
setting an operation mode of the wireless communication equipment to a router mode or an extender mode, based on a selection of a user of the wireless communication equipment;
configuring a network connection such that the wireless communication equipment operates in the router mode, when the operation mode is set to the router mode; and
configuring the network connection such that the wireless communication equipment operates in one of a plurality of sub modes included in the extender mode based at least partly on a first connection state between the wireless communication equipment and an external device or a second connection state between the wireless communication equipment and user equipment, when the operation mode is set to the extender mode.
